(19) United States
(12) Patent Application Publication
(10) Pub. No.: US 2026/0253299 A1
(43) Pub. Date: Aug. 27, 2026

(54) FACIAL MOTION DRIVING METHOD, COMPUTER-READABLE STORAGE MEDIUM, AND ELECTRONIC DEVICE

(71) Applicant: UBTECH ROBOTICS CORP LTD, Shenzhen (CN)

(72) Inventors: YUSHENG ZENG, Shenzhen (CN); Shuping Hu, Shenzhen (CN); Pei Dong, Shenzhen (CN)

(21) Appl. No.: 19/212,753

(22) Filed: May 20, 2025

(30) Foreign Application Priority Data
Feb. 27, 2025 (CN) 202510229313.2

(51) Int. Cl. G06T 13/40; G06T 13/20; G10L 25/63

(52) U.S. Cl. CPC G06T 13/40; G06T 13/205; G10L 25/63

(57) ABSTRACT

A facial motion driving method, a computer-readable storage medium, and an electronic device are provided. The method includes: obtaining a target sound for driving a facial motion; obtaining an emotional feature corresponding to the target sound by performing an emotional feature extraction processing on the target sound; processing, based on the emotional feature, the target sound using a preset three-dimensional facial motion model to obtain the three-dimensional facial motion corresponding to the target sound; and controlling a preset virtual digital human to perform the three-dimensional facial motion. In this manner, the emotional features in sounds can be extracted, and the corresponding three-dimensional facial motions can be generated based on the extracted emotional features during driving the facial motions, so that the facial motions can be as emotional as real human facial motions, which is more realistic and natural.

### CROSS REFERENCE TO RELATED APPLICATIONS

The present disclosure claims priority to Chinese Patent Application No. 202510229313.2, filed Feb. 27, 2025, which is hereby incorporated by reference herein as if set forth in its entirety.

### TECHNICAL FIELD

The present disclosure relates to facial motion driving technology, and particularly to a facial motion driving method, a computer-readable storage medium, and an electronic device.

### BACKGROUND

In the existing technology, there are quite mature methods for driving facial motions through sound. However, although the facial motions driven by the existing facial motion driving methods that mainly drive facial motions based on the content in sounds can be consistent with the content in the sounds, the performances are monotonous and rigid compared to the real human facial motions, which have a poor sense of reality.

### BRIEF DESCRIPTION OF DRAWINGS

To describe the technical schemes in the embodiments of the present disclosure or in the prior art more clearly, the following briefly introduces the drawings required for describing the embodiments or the prior art. It should be understood that, the drawings in the following description merely show some embodiments. For those skilled in the art, other drawings can be obtained according to the drawings without creative efforts.

FIG. 1 is a flow chart of a facial motion driving method according to an embodiment of the present disclosure.

FIG. 2 is a schematic diagram of expressing human three-dimensional facial motions based on Blend Shape according to an embodiment of the present disclosure.

FIG. 3 is a schematic diagram of the structure of a three-dimensional facial motion model according to an embodiment of the present disclosure.

FIG. 4 is a flow chart of determining a loss function and training a model according to an embodiment of the present disclosure.

FIG. 5 is a schematic diagram of the structure of a facial motion driving apparatus according to an embodiment of the present disclosure.

FIG. 6 is a schematic diagram of the structure of an electronic device according to an embodiment of the present disclosure.

### DETAILED DESCRIPTION

In order to make the objects, features and advantages of the present disclosure more obvious and easy to understand, the technical solutions in the embodiments of the present disclosure will be clearly and completely described below with reference to the drawings. Apparently, the described embodiments are part of the embodiments of the present disclosure, not all of the embodiments. All other embodiments obtained by those skilled in the art based on the embodiments of the present disclosure without creative efforts are within the scope of the present disclosure.

It is to be understood that, when used in the description and the appended claims of the present disclosure, the terms “including” and “comprising” indicate the presence of stated features, integers, steps, operations, elements and components, but do not preclude the presence or addition of one or a plurality of other features, integers, steps, operations, elements, components and combinations thereof.

It is also to be understood that, the terminology used in the description of the

present disclosure is only for the purpose of describing particular embodiments and is not intended to limit the present disclosure. As used in the description and the appended claims of the present disclosure, the singular forms “one”, “an”, and “the” are intended to include the plural forms as well, unless the context clearly indicates otherwise.

It is also to be further understood that the term “and or” used in the description and the appended claims of the present disclosure refers to any combination of one or more of the associated listed items and all possible combinations, and includes such combinations.

As used in the description and the appended claims, the term “if” may be interpreted as “when” or “once” or “in response to determining” or “in response to detecting” according to the context. Similarly, the phrase “if determined” or “if [the described condition or event] is detected” may be interpreted as “once determining” or “in response to determining” or “on detection of [the described condition or event]” or “in response to detecting [the described condition or event]”.

In addition, in the present disclosure, the terms “first”, “second”, “third”, and the like in the descriptions are only used for distinguishing, and cannot be understood as indicating or implying relative importance.

In the existing technology, there are quite mature methods for driving facial motions through sound. However, although the facial motions driven by the existing facial motion driving methods that mainly drive facial motions based on the content in sounds can be consistent with the content in the sounds, the performances are monotonous and rigid compared to the real human facial motions, which have a poor sense of reality.

In view of this, the embodiments of the present disclosure provide a facial motion driving method, a computer-readable storage medium, and an electronic device to solve the problem of poor sense of reality in the existing facial motion driving methods.

According to the embodiments of the present disclosure, the emotional features in sounds can be extracted, and the corresponding three-dimensional facial motions can be generated based on the extracted emotional features during driving the facial motions, so that the facial motions can be as emotional as real human facial motions, which is more realistic and natural.

In the embodiments of the present disclosure, the subject of executions may be an electronic device that is a computing device such as a mobile phone, a tablet computer, desktop computer, notebook computer, a handheld computer, a robot, or a server.

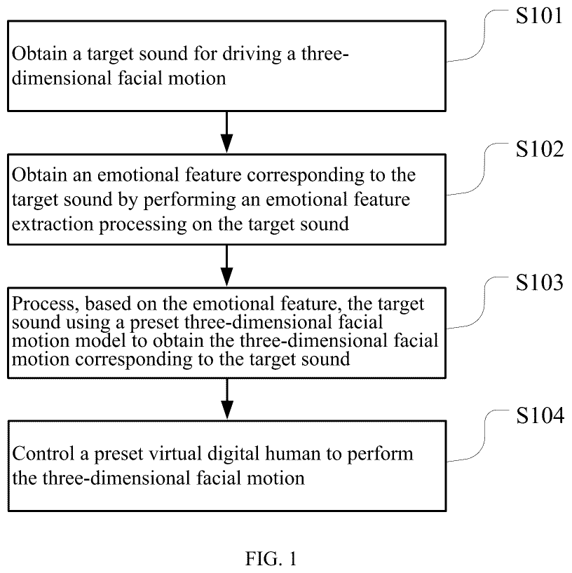

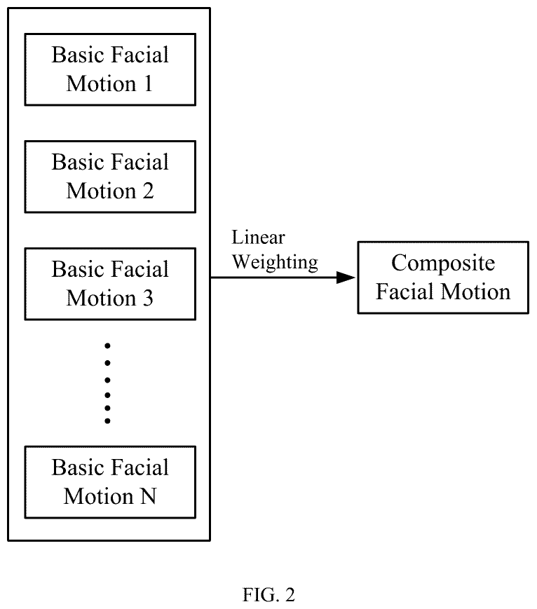

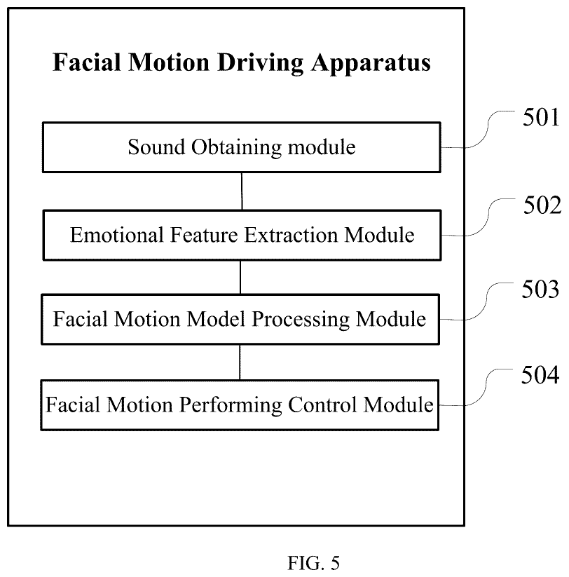

FIG. 1 is a flow chart of a facial motion driving method according to an embodiment of the present disclosure. In this embodiment, the facial motion driving method may be applied to (a processor of) an electronic device realizing a virtual digital human capable of presenting facial motions. If the electronic device is, for example, a humanoid robot including a head part, the facial motions may be motor-based three-dimensional facial motions (see FIG. 2) presented through a facial expression mechanism on the head part that is driven by motors. In other embodiments, the method may be implemented through a facial motion driving apparatus as shown in FIG. 5 or an electronic device as shown in

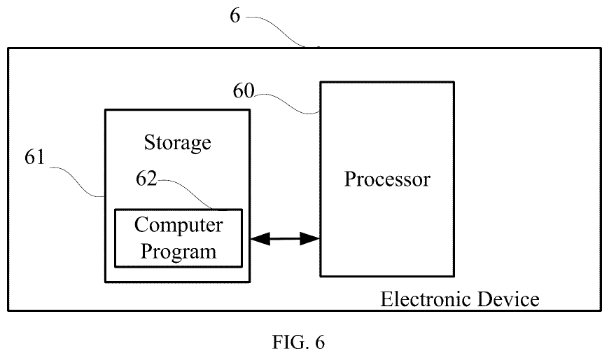

FIG. 6. As shown in FIG. 1, the facial motion driving method may include the following steps.

S101: obtaining a target sound for driving the three-dimensional facial motion.

In this embodiment, the target sound may be the sound that the electronic device will play. During playing the target sound, the electronic device needs to synchronize the corresponding facial motions to make the lip shapes and the facial expressions consistent with the target sound, thereby making the virtual digital human speaking like a human.

S102: obtaining an emotional feature corresponding to the target sound by performing an emotional feature extraction processing on the target sound.

In this embodiment, it may use any of the existing emotional feature extraction model such as the BERT model or the like to perform the emotional feature extraction processing.

Although the BERT model may be used as the emotional feature extraction model after training, it requires a large amount of data to achieve better generalization effects, hence the generalization performance when the model is trained using the public data set will be poor. Regarding the wav2vec English model, in addition to extracting English contents, it may extract certain emotional features, hence a highly generalized emotional feature extraction model (denoted as wav2vec_emo_english herein) based on the wav2vec English model may be trained by full fine-tuning.

In an example of this embodiment, it may perform the emotional feature extraction processing directly through wav2vec_emo_english, thereby obtaining the emotional feature corresponding to the target sound.

In another example of this embodiment, considering that although wav2vec_emo_english also has good emotional generalization for other non-English languages (e.g., Chinese), its spatial aggregation is not quite ideal, hence feature compensation may be further introduced to fix its shortcomings in spatial aggregation. In the case that the language corresponding to the existing emotional feature extraction model (e.g., wav2vec_emo_english) (denoted as the first language) is inconsistent with the language corresponding to the target sound (denoted as the second language), it may obtain an emotional feature extraction model corresponding to a first language; and perform a low rank adaptation (LoRA) on the obtained emotional feature extraction model using a corpus of the second language to obtain the motional feature extraction model after the LoRA.

The LoRA simulates the volume of the change of parameters through low-rank decomposition, thereby realizing indirect training of large models with extremely small amount of parameters. It multiplies two consecutive matrices A and B, where the first matrix A is responsible for reducing dimensionality, the second matrix B is responsible for upgrading dimensionality, the dimension of the intermediate layer is r, and the dimensions of the training layer and the pre-trained model layer are consistent with d. First, the dimension d is reduced to r through the fully connected layer, and then mapped from r through the fully connected layer back to the dimension d, where r<<d, and r is the rank of the matrix. Consequently, the calculation complexity of matrix is changed from d*d to d*r+r*d, where the parameter amount is greatly reduced.

For the existing emotional feature extraction model, the query vector Query (denoted as Q), key vector Key (denoted as K) and value vector Value (denoted as V) involved in its self-attention mechanism may be adjusted through the LoRA. Taking Q as an example, the left branch is the original frozen network, and the right branch is introduced with W_A and W_B parameters for learning, where the full connection layer parameter of W_A is (d,r), and that of W_B is (r,d). The parameter of the right branch that is denoted as Q^{right} is learnable, and the updated query vector that is denoted as Q′ may be obtained as Q′=Q+Q^{right}. The adjustment processes of K and V are the same as Q, where the updated key vector and value vector that are denoted as K′ and V′, respectively, may be obtained. When applying to an application, Q′, K′ and V′ may be used to substitute the original Q, K and V.

When performing the emotional feature extraction processing on the target sound, the emotional feature extraction model after applying the LoRA may be used to obtain the emotional feature corresponding to the target sound.

S103: processing, based on the emotional feature, the target sound using a preset three-dimensional facial motion model to obtain the three-dimensional facial motion corresponding to the target sound.

In which, the three-dimensional facial motions may be human three-dimensional facial motions presented based on Blend Shape (BS, a standard approach for making expressive facial animations in the digital production industry). Since human facial motions can be rich and diverse because some points on face are displaced in the space, for instance, from the perspective of visual effects, a facial motion of smiling is shown on face when some points at the corners of the mouth move diagonally upward, a human facial motion system may be designed on the basis of the similar principle to produce some basic facial motions by extracting samples from the points on face, where the basic facial motions may be regarded as the facial deformations of human in different emotional states. With these basic facial motions, various compound facial motions may be combined by adjusting their weight coefficients, where the value of the weight coefficient determines the contribution of each basic facial motion in the compound facial motion.

FIG. 2 is a schematic diagram of expressing human three-dimensional facial motions based on Blend Shape according to an embodiment of the present disclosure. As shown in FIG. 2, in that case that expresses human three-dimensional facial motions based on Blend Shape, the number of the basic facial motions is denoted as N, where N is a positive integer which may be flexibly set according to actual conditions. For example, it may be set to 52 or other values. Under different combinations of weight coefficients, these basic facial motions may be linearly weighted to obtain various composite facial motions.

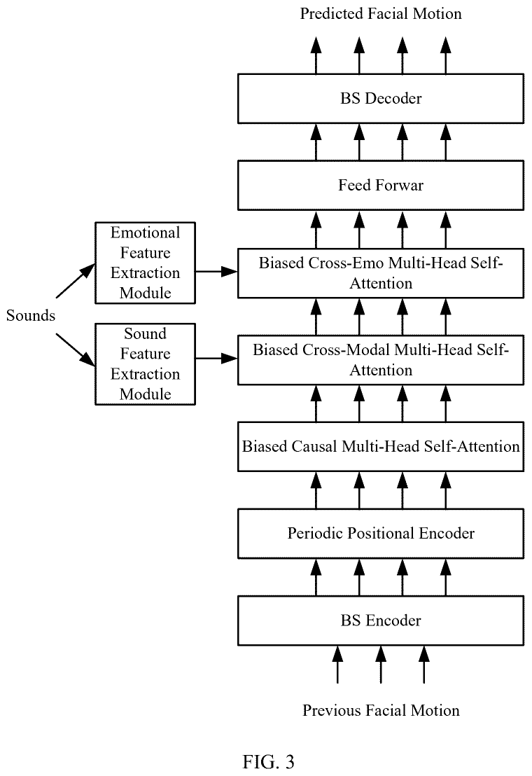

There are many existing models that generate corresponding facial motions based on sounds that present three-dimensional facial motions based on vertices or 3DMM (3D Movie Maker), while the related methods cannot be broken down into motor controls. In contrary, the standardized 52-dimensional Blend Shape can facilitate motor control by allowing motors (of the above-mentioned electronic device) to be controlled through the Blend Shape coefficients, thereby realizing motor-based three-dimensional facial motions in two stages: first, predict Blend Shape based on sound features; and second, control the motors based on the Blend Shape of the above-mentioned virtual digital human to achieve the facial motion driving of the virtual human. Therefore, in this embodiment, the three-dimensional facial motions may be expressed based on Blend Shape on the basis of these models, thereby obtaining the three-dimensional facial motion model called the 3D Face Animation Model (see FIG. 3).

The three-dimensional facial motion model may adopt the auto regressive method that initializes with the close mouth state and constantly predicts the current state based on the previous predictions and the current sound feature. FIG. 3 is a schematic diagram of the structure of the three-dimensional facial motion model according to an embodiment of the present disclosure. As shown in FIG. 3, the three-dimensional facial motion model may include a sound feature extraction module, a motion encoding module (BS Encoder), a periodic position encoding module (Periodic Positional Encoder), a biased causal multi-head self-attention module (Biased Causal Multi-Head Self-Attention), a biased cross-modal multi-head self-attention module (Biased Cross-Modal Multi-Head Self-Attention), a biased cross-emotional multi-head self-attention module (Biased Cross-Emo Multi-Head Self-Attention), a forward feedback module (Feed Forward), and a motion decoding module (BS Decoder), and the like.

Compared with the existing technology, the core difference of this model structure is that it adds the biased cross-emotional multi-head self-attention module, which can fuse the emotional feature and the output of the biased cross-modal multi-head self-attention module through a self-attention mechanism as an equation of:

$$Att ( {Q}^{\tilde{F}} , {K}^{E} , {V}^{E} , {B}^{A} ) = softmax ( \frac{{{Q}^{\tilde{F}} ( {K}^{E} )}^{T}}{\sqrt{{d}_{k}}} + {B}^{A} ) {V}^{E} ;$$

where, Q^{\tilde{F}} is the Q value corresponding to the output of the biased cross-modal multi-head self-attention module, K^{E} and V^{E} are the K value and V value corresponding to the emotional feature, B^{A} is the alignment bias, and Att is the processing function of the self-attention mechanism, and dₖ is the number of the dimensions of K^{E}.

Based on the model structure shown in FIG. 3, the process of processing the target sound through the three-dimensional facial motion model may include: obtaining a sound feature corresponding to the target sound by performing a sound feature extraction processing on the target sound; obtaining first processed data by performing a motion encoding processing on an output of the three-dimensional facial motion model; obtaining second processed data by performing a periodic position encoding processing on the first processed data; obtaining third processed data by performing biased causal multi-head self-attention processing on the second processed data; obtaining fourth processed data by performing biased cross-modal multi-head self-attention processing on the sound feature and the third processed data; obtaining fifth processed data by performing a fusion processing on the emotional feature and the fourth processed data; obtaining sixth processed data by performing a forward feedback processing on the fifth processed data; and obtaining the three-dimensional facial motion corresponding to the target sound by performing a motion decoding processing on the sixth processed data. The specific processing process may be referred to the existing models for generating corresponding facial motions based on sounds.

In this embodiment, it should be noted that the input (i.e., the previous facial motion) of the motion encoding module and the output (i.e., the currently predicted facial motion) of the motion decoding module are both the human three-dimensional facial motions expressed based on Blend Shape. In the human three-dimensional facial motions expressed based on Blend Shape, since the weight coefficients of the basic facial motions are all positive, a process for processing the sigmoid activation function may be added after the motion decoding to ensure that all the weight coefficients are positive.

In the sound feature extraction module, it may use any existing sound feature extraction model such as wav2vec model or other model to perform the sound feature extraction processing.

In the case that the language corresponding to the existing sound feature extraction model (i.e., the first language) is consistent with the language corresponding to the target sound (i.e., the second language), it may perform the sound feature extraction processing on the target sound directly through the existing sound feature extraction model to obtain the sound feature corresponding to the target sound.

In the case that the first language is inconsistent with the second language, it may fine-tune the existing sound feature extraction model using the corpus of the second language to obtain the fine-tuned sound feature extraction model, thereby improving the adaptability to the second language. For example, the language corresponding to the existing sound feature extraction model may be English, and the language corresponding to the target sound may be Chinese, then the existing sound feature extraction model may be fine-tuned using the existing sound feature extraction model to obtain the fine-tuned sound feature extraction model, thereby improving the adaptability to Chinese. It may use the fine-tuned sound feature extraction model to perform the sound feature extraction processing on the target sound, thereby obtaining the sound feature corresponding to the target sound.

The three-dimensional facial motion model may be obtained by training using the corresponding data set in advance, and the loss function used during training may be flexibly set according to actual conditions.

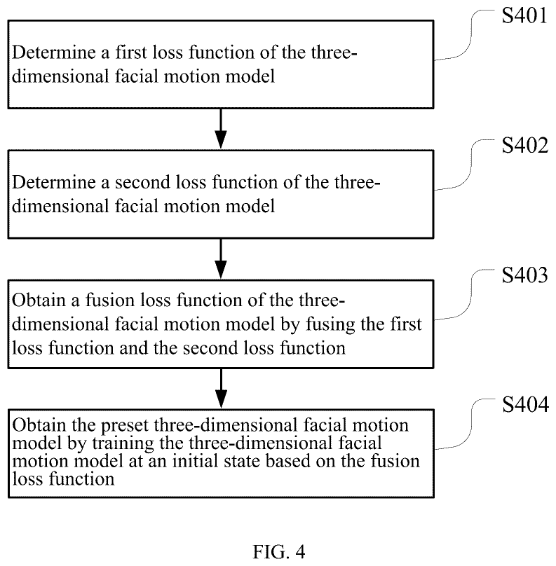

FIG. 4 is a flow chart of determining a loss function and training a model according to an embodiment of the present disclosure. As shown in FIG. 4, in this embodiment, it may determine the loss function and train the model using the shown steps.

S401: determining a first loss function of the three-dimensional facial motion model.

In which, the first loss function is a loss function for performing ground truth constraint on the three-dimensional facial motion model. Specifically, it may determine the output error of the three-dimensional facial motion model, and determine the wings function of the output error as the first loss function of the three-dimensional facial motion model, as an equation of:

$${L}_{1} = Wingloss ( \vert y - \hat{y} \vert ) ;$$

where, y is the expected output of the three-dimensional facial motion model, that is, the ground truth; ŷ is the actual output of the three-dimensional facial motion model, |y−ŷ| is the output error, that is, the absolute value of the difference between the expected output and the actual output; Wingloss is the wings function that has much better responsiveness in subtle differences than other functions and can optimize the slight error of the changes in facial motions in a more refined manner; and L₁ is the first loss function of the three-dimensional facial motion model.

S402: determining a second loss function of the three-dimensional facial motion model.

In which, the second loss function is a loss function for performing inter-frame constraint on the three-dimensional facial motion mode. Specifically, it may determine the first inter-frame difference and the second inter-frame difference of the three-dimensional facial motion model respectively, and determine the second loss function of the three-dimensional facial motion model based on the difference between the first inter-frame difference and the second inter-frame, as an equation of:

$${L}_{2} = {‖ ( {y}_{i} - {y}_{i - 1} ) - ( {\hat{y}}_{i} - {\hat{y}}_{i - 1} ) ‖}_{F}^{2} ;$$

where, (yᵢ−yᵢ₋₁) is the first inter-frame difference, that is, the difference between two frames of consecutive expected output; (yᵢ−yᵢ₋₁) is the second inter-frame difference, that is, the difference between two frames of consecutive actual outputs; (yᵢ−yᵢ₋₁)−(ŷᵢ−ŷᵢ₋₁) is the difference between the first inter-frame difference and the second inter-frame difference; and L₂ is the second loss function of the three-dimensional facial motion model.

S403: obtaining a fusion loss function of the three-dimensional facial motion model by fusing the first loss function and the second loss function.

In this embodiment, the specific fusion method may be flexibly set according to actual conditions. As an example, for the sake of simplicity, it may directly use the sum of the first loss function and the second loss function as the fusion loss function of the three-dimensional facial motion model.

S404: obtaining the preset three-dimensional facial motion model by training the three-dimensional facial motion model at an initial state based on the fusion loss function.

In this embodiment, it may use a sufficient number of training samples for training, where each training sample includes a set of sound samples and the corresponding three-dimensional facial motion tags. By using the sound samples of the training sample as the input and the corresponding three-dimensional facial motion tags as the expected output, the three-dimensional facial motion model may be trained to obtain the trained three-dimensional facial motion model.

During the training, for each training sample, the sound samples of the training sample may be processed using the three-dimensional facial motion model to obtain the actual output of the training sample, and then the fusion loss function may be used to calculate the training loss based on the expected output and actual output of the training sample. After calculating the training loss, the model parameter of the three-dimensional motion model may be adjusted accordingly.

In this embodiment, assuming that in the initial state, the model parameter of the three-dimensional facial motion model is W1, the training loss is backpropagated to modify the model parameter W1 of the three-dimensional facial motion model, thereby obtaining the modified model parameter W2. After modifying the parameter, the next training process will be continued. During this training process, the training loss is recalculated, the training loss is backpropagated to modify the model parameter W2 of the three-dimensional facial motion model, thereby obtaining the modified model parameter W3, . . . and so on. The foregoing process is constantly repeated to modify the model parameter in each training process until a preset training condition is met. In which, the training condition may be that the times of training reach a preset times threshold which may be set according to the actual condition. For example, it may be set to a value of thousands, tens of thousands, hundreds of thousands, or even larger. The training condition may also be the convergence of the three-dimensional facial motion model. Since there may be a case that the times of training not reaching the times threshold but the three-dimensional facial motion model has converged, which may lead to repetitive unnecessary work, or another case that the three-dimensional facial motion model cannot converge, which may lead to infinite loops and cannot end the training process. Regarding the foregoing two situations, the training condition may also be that the times of training reach the preset times threshold or the convergence of the three-dimensional facial motion model. The trained three-dimensional facial motion model can be obtained when the training condition is met.

Through the foregoing process, the sound samples of the training samples and the corresponding three-dimensional facial motion tags are used as the learning objects of the three-dimensional facial motion model. After the training process, the three-dimensional facial motion model can establish a mapping relationship between the sound samples and the three-dimensional facial motion tags, so that when facing new sounds, the corresponding three-dimensional facial motions can also be obtained based on the mapping relationship.

After completing the training of the three-dimensional facial motion model, the target sound may be processed using the three-dimensional facial motion model to obtain the three-dimensional facial motions corresponding to the target sound.

S104: controlling a preset virtual digital human to perform the three-dimensional facial motion.

The virtual digital human (or meta human) refers to a digital human image created using digital technology that is similar to a human image. After obtaining the three-dimensional facial motion corresponding to the target sound, it may control the virtual digital human to generate the corresponding Blend Shape expression, so that the virtual digital human can present the three-dimensional facial motion that is as similar as possible to real facial motion of human.

To sum up, in this embodiment, by obtaining a target sound for driving a facial motion; obtaining an emotional feature corresponding to the target sound by performing an emotional feature extraction processing on the target sound; processing, based on the emotional feature, the target sound using a preset three-dimensional facial motion model to obtain the three-dimensional facial motion corresponding to the target sound; and controlling a preset virtual digital human to perform the three-dimensional facial motion, the emotional features in the sound can be extracted, and the corresponding three-dimensional facial motions are generated based on the emotional feature during driving the facial motions, so that the facial motions can be as emotional as real human facial motions, which is more realistic and natural.

It should be noted that, the serial number of the steps in the foregoing-mentioned embodiments does not mean the execution order while the execution order of each process should be determined by its function and internal logic, which should not be taken as any limitation to the implementation process of the embodiments.

FIG. 5 is a schematic diagram of the structure of a facial motion driving apparatus according to an embodiment of the present disclosure. The facial motion driving apparatus corresponds to the facial motion driving method described in the foregoing embodiment, which may be a controller of an electronic device like the electronic device as shown in FIG. 6.

As shown in FIG. 5, the facial motion driving apparatus may include:

a sound obtaining module 501 configured to obtain a target sound for driving a three-dimensional facial motion;

an emotional feature extraction module 502 configured to obtain an emotional feature corresponding to the target sound by performing an emotional feature extraction processing on the target sound;

a facial motion model processing module 503 configured to process, based on the emotional feature, the target sound using a preset three-dimensional facial motion model to obtain the three-dimensional facial motion corresponding to the target sound; and

a facial motion performing control module 504 configured to control the preset virtual digital human to perform the three-dimensional facial motion.

In this embodiment, the facial motion model processing module 503 may include:

a sound feature extraction unit configured to obtain a sound feature corresponding to the target sound by performing a sound feature extraction processing on the target sound;

a motion encoding unit configured to obtain first processed data by performing a motion encoding processing on an output of the three-dimensional facial motion model;

a position encoding unit configured to obtain second processed data by performing a periodic position encoding processing on the first processed data;

a first attention processing unit configured to obtain third processed data by performing biased causal multi-head self-attention processing on the second processed data;

a second attention processing unit configured to obtain fourth processed data by performing biased cross-modal multi-head self-attention processing on the sound feature and the third processed data;

a data fusion unit configured to obtain fifth processed data by performing a fusion processing on the emotional feature and the fourth processed data;

a forward feedback unit configured to obtain sixth processed data by performing a forward feedback processing on the fifth processed data; and

a motion decoding unit configured to obtain the three-dimensional facial motion corresponding to the target sound by performing a motion decoding processing on the sixth processed data.

In one embodiment, the facial motion driving apparatus may further include:

a model fine-tuning module configured to obtain a sound feature extraction model corresponding to a first language; and

correspondingly, the sound feature extraction unit may be specifically configured to obtain the sound feature corresponding to the target sound by performing the sound feature extraction processing on the target sound through the fine-tuned sound feature extraction model.

In one embodiment, the facial motion driving apparatus may further include:

a first loss function determination module configured to determine a first loss function of the three-dimensional facial motion model, wherein the first loss function is a loss function for performing ground truth constraint on the three-dimensional facial motion model;

a second loss function determination module configured to determine a second loss function of the three-dimensional facial motion model, wherein the second loss function is a loss function for performing inter-frame constraint on the three-dimensional facial motion model;

a fusion loss function determination module configured to obtain a fusion loss function of the three-dimensional facial motion model by fusing the first loss function and the second loss function; and

a model training module configured to obtain the preset three-dimensional facial motion model by training the three-dimensional facial motion model at an initial state based on the fusion loss function.

In one embodiment, the first loss function determination module may be specifically configured to determine an output error of the three-dimensional facial motion model, wherein the output error is an absolute value of the difference between an expected output and an actual output of the three-dimensional facial motion model; and determine wings function of the output error as the first loss function of the three-dimensional facial motion model.

In one embodiment, the second loss function determination module may be specifically configured to determine a first inter-frame difference of the three-dimensional facial motion model, wherein the first inter-frame difference is the difference between two consecutive frames of expected outputs of the three-dimensional facial motion model; determine a second inter-frame difference of the three-dimensional facial motion model, wherein the second inter-frame difference is the difference between two consecutive frames of actual outputs of the three-dimensional facial motion model; and determine, based on the difference between the first inter-frame difference and the second inter-frame difference, the second loss function of the three-dimensional facial motion model.

In one embodiment, the facial motion driving apparatus may further include:

a low-rank adaptation adjustment module configured to obtain an emotional feature extraction model corresponding to a first language; and perform a low rank adaptation on the obtained emotional feature extraction model using a corpus of a second language; and

correspondingly, the emotional feature extraction module 502 may be specifically configured to: obtain the emotional feature corresponding to the target sound by performing the emotional feature extraction processing on the target sound through the emotional feature extraction model after the low rank adaptation.

Those skilled in the art may clearly understand that, for the convenience and simplicity of description, for the specific operation process of the foregoing-mentioned device, modules and units, reference may be made to the corresponding processes in the foregoing-mentioned method embodiments, which will not be described herein.

In the foregoing-mentioned embodiments, the description of each embodiment has its focuses, and the parts which are not described or mentioned in one embodiment may refer to the related descriptions in other embodiments.

FIG. 6 is a schematic diagram of the structure of an electronic device according to an embodiment of the present disclosure. For convenience of description, only the parts related to this embodiment are shown.

As shown in FIG. 6, in this embodiment, the electronic device 6 includes a processor 60, a storage 61, and a computer program 62 stored in the storage 61 and executed on the processor 60. The processor 60 implements the steps in the foregoing-mentioned embodiments of the computer program 62, for example, steps S101-S104 shown in FIG. 1, or the processor 60 implements the functions of each module unit in the foregoing-mentioned embodiments, for example, the functions of the modules 501-504 shown in FIG. 5.

Exemplarily, the computer program 62 may be divided into one or more modules/units, and the one or more modules/units are stored in the storage 61 and executed by the processor 60 to realize the present disclosure. The one or more modules/units may be a series of computer program instruction sections capable of performing a specific function, and the instruction sections are for describing the execution process of the computer program 62 in the electronic device 6.

The electronic device 6 may include but is not limited to a computing device such as a mobile phone, a tablet computer, a desktop computer, a notebook computer, a handheld computer, a robot, and a server. It can be understood by those skilled in the art that FIG. 6 is merely an example of the terminal device 6 and does not constitute a limitation on the terminal device 6, and may include more or fewer components than those shown in the figure, or a combination of some components or different components. For example, the terminal device 6 may further include an input/output device, a network access device, a bus, and the like.

The processor 60 may be a central processing unit (CPU), or be other general purpose processor, a digital signal processor (DSP), an application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

The storage 61 may be an internal storage unit of the electronic device 6, for example, a hard disk or a memory of the electronic device 6. The storage 61 may also be an external storage device of the electronic device 6, for example, a plug-in hard disk, a smart media card (SMC), a secure digital (SD) card, flash card, and the like, which is equipped on the electronic device 6. Furthermore, the storage 61 may further include both an internal storage unit and an external storage device, of the electronic device 6. The storage 61 is configured to store the computer program 62 and other programs and data required by the electronic device 6. The storage 61 may also be used to temporarily store data that has been or will be output.

Those skilled in the art may clearly understand that, for the convenience and simplicity of description, the division of each of the foregoing-mentioned functional units and modules is merely an example for illustration. In actual applications, the foregoing-mentioned functions may be allocated according to requirements, that is, the internal structure of the device may be divided into different functional units or modules to complete all or part of the foregoing-mentioned functions. each functional unit in the embodiments may be integrated into one processing unit, or each unit may exist alone physically, or two or more units may be integrated in one unit. The foregoing-mentioned integrated unit may be implemented in the form of hardware or in the form of software functional unit. In addition, the specific name of each functional unit and the module is merely for the convenience of distinguishing each other and is not intended to limit the scope of each protection unit and the specific operation process of the foregoing-mentioned system, reference may be made to the corresponding process in the foregoing-mentioned method, which will not be described herein.

In the foregoing-mentioned embodiments, the description of each embodiment has its focuses, and the parts which are not described or mentioned in one embodiment may refer to the related descriptions in other embodiments.

Those skilled in the art may clearly understand that, the exemplificative units and steps described in the embodiments disclosed herein may be implemented in electronic hardware or a combination of computer software and electronic hardware. Whether these functions are implemented through hardware or software depends on the specific application and design constraints of the technical schemes. Those ordinary skilled in the art may implement the described functions in different manners for each particular application, while this implementation should not be considered as be within the scope of the present disclosure.

In the embodiments provided by the present disclosure, it should be noted that the disclosed apparatus and method of the apparatus electronic device may be implemented in other manners. For example, the foregoing-mentioned embodiment(s) of the apparatus may be merely exemplary. For example, the division of modules or units is merely a logical functional division, and other division manner may be used in actual implementations, for example, multiple units or components may be combined or be integrated into another system, or some of the features may be ignored or not performed. In addition, the disclosure coupling or communication connection may be direct coupling or communication connection through some interfaces, devices or units, and may also be electrical, mechanical or other forms.

The units described as separate components may or may not be physically separated. The components represented as units may or may not be physical units, that is, may be located in one place or be distributed to multiple network units. Some or all of the units may be selected according to actual needs to achieve the purpose of this embodiment.

In addition, each functional unit in each embodiment of the present disclosure may be integrated into one processing unit, or each unit may exist physically only, or two or more units may be integrated in one unit. The foregoing-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure are implemented, and may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any entity or device capable of carrying the computer program codes, a recording medium, a USB flash drive, a portable hard disk, a magnetic disk, an optical disk, a computer memory, a read-only memory (ROM), a random access memory (RAM), electric carrier signals, telecommunication signals and software distribution media. It should be noted that the content contained in the computer-readable medium may be appropriately increased or decreased according to the requirements of legislation and patent practice in the jurisdiction. For example, in some jurisdictions, according to the legislation and patent practice, a computer-readable medium does not include electric carrier signals and telecommunication signals.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

What is claimed is:

1. A method for driving a three-dimensional facial motion of a virtual digital human, comprising:
obtaining a target sound for driving the three-dimensional facial motion;
obtaining an emotional feature corresponding to the target sound by performing an emotional feature extraction processing on the target sound;
processing, based on the emotional feature, the target sound using a preset three-dimensional facial motion model to obtain the three-dimensional facial motion corresponding to the target sound; and
controlling the virtual digital human to perform the three-dimensional facial motion.

2. The method of claim 1, wherein processing, based on the emotional feature, the target sound using the preset three-dimensional facial motion model to obtain the three-dimensional facial motion corresponding to the target sound comprises:
obtaining a sound feature corresponding to the target sound by performing a sound feature extraction processing on the target sound;
obtaining first processed data by performing a motion encoding processing on an output of the three-dimensional facial motion model;
obtaining second processed data by performing a periodic position encoding processing on the first processed data;
obtaining third processed data by performing biased causal multi-head self-attention processing on the second processed data;
obtaining fourth processed data by performing biased cross-modal multi-head self-attention processing on the sound feature and the third processed data;
obtaining fifth processed data by performing a fusion processing on the emotional feature and the fourth processed data;
obtaining sixth processed data by performing a forward feedback processing on the fifth processed data; and
obtaining the three-dimensional facial motion corresponding to the target sound by performing a motion decoding processing on the sixth processed data.

3. The method of claim 2, wherein before obtaining the sound feature corresponding to the target sound by performing the sound feature extraction processing on the target sound, the method further comprises:
obtaining a sound feature extraction model corresponding to a first language; and
obtaining the fine-tuned sound feature extraction model by fine-tuning the obtained sound feature extraction model using a corpus of a second language; and
obtaining the sound feature corresponding to the target sound by performing the sound feature extraction processing on the target sound comprises:
obtaining the sound feature corresponding to the target sound by performing the sound feature extraction processing on the target sound through the fine-tuned sound feature extraction model.

4. The method of claim 1, wherein before processing, based on the emotional feature, the target sound using the preset three-dimensional facial motion model, the method further comprises:
determining a first loss function of the three-dimensional facial motion model, wherein the first loss function is a loss function for performing ground truth constraint on the three-dimensional facial motion model;
determining a second loss function of the three-dimensional facial motion model, wherein the second loss function is a loss function for performing inter-frame constraint on the three-dimensional facial motion model;
obtaining a fusion loss function of the three-dimensional facial motion model by fusing the first loss function and the second loss function; and
obtaining the preset three-dimensional facial motion model by training the three-dimensional facial motion model at an initial state based on the fusion loss function.

5. The method of claim 4, wherein determining the first loss function of the three-dimensional facial motion model comprises:
determining an output error of the three-dimensional facial motion model, wherein the output error is an absolute value of the difference between an expected output and an actual output of the three-dimensional facial motion model; and
determining a wings function of the output error as the first loss function of the three-dimensional facial motion model.

6. The method of claim 4, wherein determining the second loss function of the three-dimensional facial motion model comprises:
determining a first inter-frame difference of the three-dimensional facial motion model, wherein the first inter-frame difference is the difference between two consecutive frames of expected outputs of the three-dimensional facial motion model;
determining a second inter-frame difference of the three-dimensional facial motion model, wherein the second inter-frame difference is the difference between two consecutive frames of actual outputs of the three-dimensional facial motion model; and
determining, based on the difference between the first inter-frame difference and the second inter-frame difference, the second loss function of the three-dimensional facial motion model.

7. The method of claim 1, wherein before obtaining the emotional feature corresponding to the target sound by performing the emotional feature extraction processing on the target sound, the method further comprises:
obtaining an emotional feature extraction model corresponding to a first language; and
performing a low rank adaptation on the obtained emotional feature extraction model using a corpus of a second language; and
obtaining the emotional feature corresponding to the target sound by performing the emotional feature extraction processing on the target sound, the method further comprises:
obtaining the emotional feature corresponding to the target sound by performing the emotional feature extraction processing on the target sound through the emotional feature extraction model after the low rank adaptation.

8. A non-transitory computer-readable storage medium for storing one or more computer programs, wherein the one or more computer programs comprise:
instructions for obtaining a target sound for driving a three-dimensional facial motion;
instructions for obtaining an emotional feature corresponding to the target sound by performing an emotional feature extraction processing on the target sound;
instructions for processing, based on the emotional feature, the target sound using a preset three-dimensional facial motion model to obtain the three-dimensional facial motion corresponding to the target sound; and
instructions for controlling a virtual digital human to perform the three-dimensional facial motion.

9. The storage medium of claim 8, wherein the instructions for processing, based on the emotional feature, the target sound using the preset three-dimensional facial motion model to obtain the three-dimensional facial motion corresponding to the target sound comprise:
instructions for obtaining a sound feature corresponding to the target sound by performing a sound feature extraction processing on the target sound;
instructions for obtaining first processed data by performing a motion encoding processing on an output of the three-dimensional facial motion model;
instructions for obtaining second processed data by performing a periodic position encoding processing on the first processed data;
instructions for obtaining third processed data by performing biased causal multi-head self-attention processing on the second processed data;
instructions for obtaining fourth processed data by performing biased cross-modal multi-head self-attention processing on the sound feature and the third processed data;
instructions for obtaining fifth processed data by performing a fusion processing on the emotional feature and the fourth processed data;
instructions for obtaining sixth processed data by performing a forward feedback processing on the fifth processed data; and
instructions for obtaining the three-dimensional facial motion corresponding to the target sound by performing a motion decoding processing on the sixth processed data.

10. The storage medium of claim 9, wherein the one or more computer programs further comprise:
instructions for obtaining a sound feature extraction model corresponding to a first language; and
instructions for obtaining the fine-tuned sound feature extraction model by fine-tuning the obtained sound feature extraction model using a corpus of a second language; and
the instructions for obtaining the sound feature corresponding to the target sound by performing the sound feature extraction processing on the target sound comprise:
instructions for obtaining the sound feature corresponding to the target sound by performing the sound feature extraction processing on the target sound through the fine-tuned sound feature extraction model.

11. The storage medium of claim 8, wherein the one or more computer programs further comprise:
instructions for determining a first loss function of the three-dimensional facial motion model, wherein the first loss function is a loss function for performing ground truth constraint on the three-dimensional facial motion model;
instructions for determining a second loss function of the three-dimensional facial motion model, wherein the second loss function is a loss function for performing inter-frame constraint on the three-dimensional facial motion model;
instructions for obtaining a fusion loss function of the three-dimensional facial motion model by fusing the first loss function and the second loss function; and
instructions for obtaining the preset three-dimensional facial motion model by training the three-dimensional facial motion model at an initial state based on the fusion loss function.

12. The storage medium of claim 11, wherein the instructions for determining the first loss function of the three-dimensional facial motion model comprise:
instructions for determining an output error of the three-dimensional facial motion model, wherein the output error is an absolute value of the difference between an expected output and an actual output of the three-dimensional facial motion model; and
instructions for determining a wings function of the output error as the first loss function of the three-dimensional facial motion model.

13. The storage medium of claim 11, wherein the instructions for determining the second loss function of the three-dimensional facial motion model comprise:
instructions for determining a first inter-frame difference of the three-dimensional facial motion model, wherein the first inter-frame difference is the difference between two consecutive frames of expected outputs of the three-dimensional facial motion model;
instructions for determining a second inter-frame difference of the three-dimensional facial motion model, wherein the second inter-frame difference is the difference between two consecutive frames of actual outputs of the three-dimensional facial motion model; and
instructions for determining, based on the difference between the first inter-frame difference and the second inter-frame difference, the second loss function of the three-dimensional facial motion model.

14. An electronic device for driving a three-dimensional facial motion of a virtual digital human, comprising:
a processor;
a memory coupled to the processor; and
one or more computer programs stored in the memory and executable on the processor;
wherein, the one or more computer programs comprise:
instructions for obtaining a target sound for driving the three-dimensional facial motion;
instructions for obtaining an emotional feature corresponding to the target sound by performing an emotional feature extraction processing on the target sound;
instructions for processing, based on the emotional feature, the target sound using a preset three-dimensional facial motion model to obtain the three-dimensional facial motion corresponding to the target sound; and
instructions for controlling the virtual digital human to perform the three-dimensional facial motion.

15. The electronic device of claim 14, wherein the instructions for processing, based on the emotional feature, the target sound using the preset three-dimensional facial motion model to obtain the three-dimensional facial motion corresponding to the target sound comprise:
instructions for obtaining a sound feature corresponding to the target sound by performing a sound feature extraction processing on the target sound;
instructions for obtaining first processed data by performing a motion encoding processing on an output of the three-dimensional facial motion model;
instructions for obtaining second processed data by performing a periodic position encoding processing on the first processed data;
instructions for obtaining third processed data by performing biased causal multi-head self-attention processing on the second processed data;
instructions for obtaining fourth processed data by performing biased cross-modal multi-head self-attention processing on the sound feature and the third processed data;
instructions for obtaining fifth processed data by performing a fusion processing on the emotional feature and the fourth processed data;
instructions for obtaining sixth processed data by performing a forward feedback processing on the fifth processed data; and
instructions for obtaining the three-dimensional facial motion corresponding to the target sound by performing a motion decoding processing on the sixth processed data.

16. The electronic device of claim 15, wherein the one or more computer programs further comprise:
instructions for obtaining a sound feature extraction model corresponding to a first language; and
instructions for obtaining the fine-tuned sound feature extraction model by fine-tuning the obtained sound feature extraction model using a corpus of a second language; and
the instructions for obtaining the sound feature corresponding to the target sound by performing the sound feature extraction processing on the target sound comprise:
instructions for obtaining the sound feature corresponding to the target sound by performing the sound feature extraction processing on the target sound through the fine-tuned sound feature extraction model.

17. The electronic device of claim 14, wherein the one or more computer programs further comprise:
instructions for determining a first loss function of the three-dimensional facial motion model, wherein the first loss function is a loss function for performing ground truth constraint on the three-dimensional facial motion model;
instructions for determining a second loss function of the three-dimensional facial motion model, wherein the second loss function is a loss function for performing inter-frame constraint on the three-dimensional facial motion model;
instructions for obtaining a fusion loss function of the three-dimensional facial motion model by fusing the first loss function and the second loss function; and
instructions for obtaining the preset three-dimensional facial motion model by training the three-dimensional facial motion model at an initial state based on the fusion loss function.

18. The electronic device of claim 17, wherein the instructions for determining the first loss function of the three-dimensional facial motion model comprise:
instructions for determining an output error of the three-dimensional facial motion model, wherein the output error is an absolute value of the difference between an expected output and an actual output of the three-dimensional facial motion model; and
instructions for determining a wings function of the output error as the first loss function of the three-dimensional facial motion model.

19. The electronic device of claim 17, wherein the instructions for determining the second loss function of the three-dimensional facial motion model comprise:
instructions for determining a first inter-frame difference of the three-dimensional facial motion model, wherein the first inter-frame difference is the difference between two consecutive frames of expected outputs of the three-dimensional facial motion model;
instructions for determining a second inter-frame difference of the three-dimensional facial motion model, wherein the second inter-frame difference is the difference between two consecutive frames of actual outputs of the three-dimensional facial motion model; and
instructions for determining, based on the difference between the first inter-frame difference and the second inter-frame difference, the second loss function of the three-dimensional facial motion model.

20. The electronic device of claim 14, wherein the one or more computer programs further comprise:
instructions for obtaining an emotional feature extraction model corresponding to a first language; and
instructions for performing a low rank adaptation on the obtained emotional feature extraction model using a corpus of a second language; and
the instructions for obtaining the emotional feature corresponding to the target sound by performing the emotional feature extraction processing on the target sound, the method further comprise:
instructions for obtaining the emotional feature corresponding to the target sound by performing the emotional feature extraction processing on the target sound through the emotional feature extraction model after the low rank adaptation.
